(19) United States
(12) Patent Application Publication
(10) Pub. No.: US 2004/0186818 A1
(43) Pub. Date: Sep. 23, 2004

(54) Digital drafting table

(76) Inventor: Corey Bowlus, San Diego, CA (US)

Correspondence Address: Corey Bowlus, 4162 Ingalls Street, San Diego, CA, 92103, US

(21) Appl. No.: 10/281,892

(22) Filed: Oct. 29, 2002

(51) Int. Cl. G06F 7/00

(52) U.S. Cl. 707/1

(57) ABSTRACT

Never before has an engineer been able to transmit to the personal computer actual working drawings as they are being created on a drafting table. To date, the engineer must scan a completed rendering. The digital drafting table will eliminate the original methods. In addition, a network of the digital drafting table in a classroom environment will enable a teacher to oversee a student's progress as they work.

### BACKGROUND OF INVESTIGATION

The technical field for which this invention, classified as a personal computing peripheral technical tool (computer hardware), would be used in the following manner:

Computer Aided Drafting (“CAD”)

Architectural Renderings

Digital Arts and Computer Animation

Engineering Fields

With reference to specific problems in the prior art of the technical drafting table there have been no applications which enable the user to transmit in real time, to personal computers, real size manipulate able renderings of their original drawings. In the past, if the user wanted to input a full size rendering into thuier personal computer for storage, manipulation, or printing, the user would have to use a full, industrial sized scanner to import their renderings and deliver their originals to a printer for blueprints.

### SUMMARY OF INVENTION

This unique new drafting table and digital pencil/pen set will enable architects, engineers, drafters and animators alike to work on a traditional style drafting table environment using ink and lead. What makes this table exceptional is the ability to transmit in real time, to personal computers, original full sized artist renderings.

This is achieved with a device incorporate into a traditional drafting table. This device reads the “x”, “y” axis being plotted with an electrical mechanical pencil.

The digital tools used in this device will include; electronic mechanical pencil, “x” and “y” coordinate receiver, battery recharging input, all of which will eliminate the need for bulky industrial scanning computer equipment currently being used in these fields. With the original already imported in the computer you will be able to email your drawings to your clients for review or printer for blueprints, saving time and costs.

### DESCRIPTION OF THE SEVERAL VIEWS OF THE DRAWING

Pending correspondence from USPTO.

Top view:

Side view:

3d view:

Due to the varying degree of ergonomics the graphical representations, drawings, and schematics to be contained in the “Digital Drafting Table”, may vary dramatically according to user preference.

### DETAILED DESCRIPTION OF THE INVENTION

This invention consists of a tradition styled drafting table with mounted parallel. It is intended that there will be the incorporation, in the upper right hand corner of the table, one electronic mechanical pencil recharging unit. The recharging unit obtains its power from a typical AC electrical cord. The recharging units purpose is to recharge the power needed to run the electronic mechanical pencil. This mechanical pencil is a typical reusable lead type pencil, which features an electronic beam that transmits coordinates to the XY access receiver. The electronic mechanical pencil is a wireless device.

The XY access receiver located in the upper left hand corner of the drafting table will be connected to any personal computer via a serial port receiver.

What I claim as my invention is:

1. The “Digital Drafting Table”, is a technical utility tool for architects and engineers to input original working drawings into the personal computer environment by way of an X-Y axis devise built into the table that reads the coordinates plotted by the user with an electronic pencil. In essence, the digital drafting table will enable the user to simultaneously create an original design content and a digital reproduction in real time.
